(19) United States
(12) Patent Application Publication
(10) Pub. No.: US 2019/0264980 A1
(43) Pub. Date: Aug. 29, 2019

(54) CRUCIBLE FOR MELTING REACTIVE ALLOYS

(71) Applicant: General Electric Company, Schenectady, NY (US)

(72) Inventors: Benjamin WEIDEHOFF, Regensburg (DE); Michael LIEBL, Regensburg (DE)

(21) Appl. No.: 15/904,573

(22) Filed: Feb. 26, 2018

(51) Int. Cl. F27B 14/10; B23P 15/00

(52) U.S. Cl. CPC F27B 14/10; B23P 15/00; B23P 2700/12; F27B 2014/102; F27B 2014/104

(57) ABSTRACT

A ceramic crucible having an Al₂TiO₅ body with face layers of non-reactive ceramic and a method of making the crucible. The ceramic crucible is made by utilizing a plaster mold and forming a crucible body as backing material in the plaster mold with a slurry. The slurry is fired to form the crucible body of aluminum titanate. Non-reactive ceramic slurry is applied to the interior of the crucible body to a predetermined thickness, wetting the crucible body and then fired forming a non-reactive layer as the interior surface of the ceramic crucible. The non-reactive layer forming the interior surface of the ceramic crucible is more dense than non-reactive layers in prior art crucibles. The dense non-reactive layer forms a stronger bond with the crucible body, reducing the potential for delamination of the non-reactive layer when a reactive alloy is melted in the crucible by vacuum induction melting.

### FIELD OF THE INVENTION

This invention is directed to crucibles having a ceramic coating and more specifically, with a non-reactive ceramic coating that is applied to an aluminum titanate ceramic and a method for making such a crucible.

### BACKGROUND OF THE INVENTION

Vacuum induction melting is a method frequently used to fabricate turbine engine components such as airfoils. It generally involves heating a metal in a crucible comprising a non-conductive refractory oxide until the charge of metal within the crucible is in the liquid state. When melting highly reactive metals such as titanium or its alloys, vacuum induction melting using cold wall crucibles is employed.

State of the art crucibles are made by providing a sacrificial pattern, typically a wax pattern although patterns made of other sacrificial material may be used. The pattern has the shape of the crucible cavity. The first coating that will form the inner surface of the crucible is applied to the wax pattern, typically by immersion into a slurry and addition of solid particles, which may be ceramic particles, either the same or different as included in the slurry, or as other non-organic materials, such as fibers applied to the wax pattern after the slurry immersion. The pattern is allowed to dry before the next immersion. Additional coating layers are applied and then additional ceramic layers, typically an alumina slurry or other ceramic slurry that may or may not include alumina, are applied to an appropriate thickness by the slurry immersion process described above. The structure is then heated to melt or vaporize the sacrificial material or cooled to contract and remove sacrificial material from the dried structure. The resulting structure is a cavity that has the shape of a net product or near-net product. If the resultant product is complex, such as a turbine blade, cores may be added to the mold to provide passageways when the mold is finished. In its simplest form, the mold is a simple cavity for holding a liquid charge taking the form of a crucible. The mold may be fired at an elevated temperature. The crucible may be used for melting an alloy by induction melting, induction coils with associated cooling coils and a susceptor or susceptors which improves uniformity of heat distribution by improving uniformity of the induced magnetic field may be attached to the crucible before firing. Thus, current technology “builds” or forms the crucible from the inner surface, or surface contacting the molten metal outwardly. The molten metal in the crucible may then be used to supply molten metal to more complex molds having gating and riser systems for forming more articles such as turbine blades.

Melting and casting using ceramic crucibles can introduce sufficient thermal stresses to damage the crucible, reducing crucible life and function and introducing impurities into the metal being melted in the crucible. In order to eliminate or minimize reactions of highly reactive alloys with the crucible, the coatings forming the inner surface of the crucible are not reactive with highly reactive alloys once the alloys are molten. However, state of the art crucibles coated with non-reactive coatings still encounter damage as induction melts the metal charge in the crucible, heating the crucible from the inside. Crucible damage includes not only cracks to the crucible, but damage to the coatings lining the crucible, such as delamination of the coatings as the crucible undergoes thermal expansion as the alloy charge is heated to its melting temperature, as well as cracks in the coating.

The crucible used in vacuum induction melting utilizes induction coils for heating and cooling coils to keep the crucible cool. Heating is accomplished by an electric current passed through the induction coils inducing a current in the charge inside the crucible. Cold-walled crucibles further include copper tubing cooled by water, cooling the induction coils and the crucible. The magnetic field produced by the induction coils causes stirring of liquid metal in the crucible.

Highly reactive alloys, such as titanium aluminide alloys, can react with the refractory compositions used to fabricate the crucibles at the melting temperatures of the titanium aluminum alloys. The attack of the reactive composition comprising the crucible can result in contamination of the alloy being melted, resulting in damage to the crucible and inclusions in the alloy when cast. When graphite or graphite-lined crucibles are used, carbon from the crucible or its lining contaminates the alloy melt. In either case, the contamination is undesirable, resulting in degradation of the mechanical properties of the cast alloy.

While graphite crucibles requiring no non-reactive layers, and hence no delamination, offer a possible alternative, these graphite crucibles necessarily release carbon into the molten alloy, altering the chemical composition of the molten alloy. The release of carbon is a function of the temperature and the time that molten metal is in contact with the graphite crucible. The change in composition can result in deterioration in the mechanical properties of the article formed from the molten alloy.

Thus, there is a desire for crucibles for melting highly reactive alloys, such as titanium aluminide, that will not react with the reactive alloy to cross-contaminate it.

### BRIEF DESCRIPTION OF THE INVENTION

A crucible comprises a high temperature refractory material comprising a ceramic titanate. The inner surface of the crucible that will contact the highly reactive molten alloy is coated with at least one layer of a material that is not reactive with the molten alloy in the crucible. The resulting crucible thus comprises a high temperature titanate ceramic material and at least one layer of a material that is not reactive with the alloy that is melted, the outer layer of the at least one material layer when more than one layer of materials are used being in contact with the molten alloy. Induction coils may be attached to the outer surface of the crucible.

A novel method for fabricating the crucible includes first forming the crucible and then applying the non-reactive coating(s) to the interior surface of the crucible, which is in contrast to the “lost wax process” currently used in the art and described above. A plaster mold having a cavity slightly larger than the desired cavity is provided. This mold is then coated with a slurry of the high temperature ceramic titanate. The slurry dries against the side of the plaster mold by water extraction into and through the plaster mold. The process is repeated until a desired thickness of the high temperature alloy is achieved. The plaster mold may be removed and the dried high temperature ceramic titanate material is then fired, consolidating the high temperature material. At least one coating of non-reactive material is applied as a slurry to the inside surface of the high temperature fired ceramic titanate crucible and allowed to dry. Additional layers are added and dried as needed. After the non-reactive layer or layers are added to a desired thickness, the structure is fired again to bond the layers to the high temperature ceramic titanate crucible.

The use of a crucible prepared in accordance with the present invention for melting reactive alloys reduces imperfections and inclusions in the molten alloy, which minimizes inclusions and casting defects in the casting. Defects resulting from the non-reactive coating, which typically is yttria or yttria-based, are reduced.

The non-reactive coating does not delaminate from the crucible primarily because no stucco is used in forming the crucible, such as is used in prior art crucibles and prior art methods for forming crucibles. The structure of the ceramic titanate crucible thus lacks porosity resulting from air entrapped between the stucco grains. This porosity, which weakens the structure, is not present in the ceramic titanate crucible formed by the process of making the ceramic titanate crucible as set forth previously. As a result, surprisingly the facecoat, or coating layer, which is in contact with the molten metal, does not delaminate from the crucible body. The high temperature ceramic titanate crucible is more responsive to temperature changes than the prior art ceramic crucibles, expanding and contracting more consistently with the thin non-reactive coating layer(s) due to the absence of porosity than prior art ceramic crucibles.

An advantage of the crucible of the present invention is that a susceptor, such as used in prior art ceramic molds to improve the uniformity of heat distribution, is no longer needed.

Another advantage of the present process is that the facecoat applied to the high temperature ceramic titanate comprising the crucible is denser than facecoats formed using the prior art “lost wax” process is which the facecoat is the first formed structure utilizing stucco. The denser facecoat layer formed by the present invention has greater strength than facecoats formed by the lost wax process incorporating stucco and its strength-reducing porosity.

The crucibles made in accordance with the present invention are made in fewer steps producing a more controllable shape than crucibles made in accordance with the “lost wax” process. Since they require fewer steps with less equipment, they inherently have a cost advantage due to the high cost of yttria-based coatings forming the outer layer(s) made by the “lost wax” process.

The crucibles made in accordance with the present invention involve fewer process steps, making them easier and cheaper to make, providing additional cost advantages.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a cross-section depicting a ceramic crucible body formed in a plaster mold as set forth herein.

FIGS. 2A, 2B, and 2C depict critical steps following the step depicted in FIG. 1 for preparing the ceramic body for application of the non-reactive layer and a method for applying a slurry of the non-reactive layer.

FIG. 3 is a magnified view of a non-reactive yttria layer applied to an aluminum titanate crucible depicting the improved density of the yttria layer formed on the aluminum titanate crucible formed by the process set forth herein.

FIG. 4 depicts a cross-section of a prior art crucible illustrating the shape of the crucible cavity. The cavity includes a charge of reactive alloy.

### DETAILED DESCRIPTION OF THE INVENTION

A crucible for melting reactive metals that reduces inclusions in the alloy, a method for fabricating such a crucible and a crucible made by the unique process is set forth. Current crucibles for melting reactive metals utilize a ceramic body having at least one layer of a coating that is not reactive with molten metal within the crucible. The at least one layer of non-reactive coating comprises yttrium oxide (yttria), scandium oxide (scandia), zirconium oxide (zirconia), calcium oxide (calcia), hafnium oxide (hafnia), and/or a lanthanide series oxide either alone or in combination. The ceramic body, which is backing material behind the non-reactive coating forming the crucible, comprises a ceramic such as alumina, zirconium silicate, and/or silicon dioxide.

The prior art crucibles are formed by a “lost wax” process using a pattern that has the desired shape of the interior of the crucible, the pattern being a consumable material. The wax pattern is formed by applying wax to a mold having the desired shape of the article to be formed, here a crucible. The process is referred to as the lost wax process because the pattern usually comprises wax, although other consumable material such as wood or plastic may be used. The non-reactive coating is the first material applied to the pattern, typically as a slurry and usually by an immersion process. Ceramic or other inorganic particles or fibers may be added to the slurry on the wax pattern before it is dried. The slurry is allowed to dry and additional non-reactive coating layers are applied as needed. Stucco is applied between each layer. After drying, the consumable material optionally may be removed. Usually, a slurry of material comprising the crucible is applied over the non-reactive coating layers and allowed to dry. The slurry usually is applied in multiple passes and allowed to dry until the desired thickness is obtained. The consumable material is removed, if it has not already been removed, and the dried crucible is then fired. The resulting crucible may require a susceptor to uniformly distribute heat, that is, uniformly apply the induced field, to the interior of the crucible.

The resulting crucible has coating layer(s) that are porous. The ceramic backing forming the body of the crucible supporting the coating layer(s) also includes porosity resulting from the stucco usage. The porosity at the interface between coating layers, when more than one layer is used and between the body of the crucible and the coating layer(s) contribute to weakness of the bond at said interfaces. The thermal expansion, occurring during melting of the alloy charge, results in thermal stresses at these interfaces due to differential thermal expansion between the layer(s) and the crucible body, thermal expansion occurring at a greater rated from the non-reactive coating layers outwardly into the crucible body. These stresses are sufficient to result in delamination of the applied layers. This porosity thus contributes to weakness in the coating layer(s) resulting in delamination of the coating layers as the furnace charge is melted.

The present invention utilizes a crucible comprising a backing made from a dense ceramic titanate and a face layer overlying the dense ceramic titanate comprising a material that is non-reactive with a reactive metal melt. The reactive metal melt material occupies the interior of the crucible and is in contact with the face layer. While the face layer is in contact with the reactive metal melt material, one or more additional layers of ceramic material may be positioned between the face layer and the dense ceramic backing material. The crucible is constructed by a method that is different from current methods for constructing crucibles, such as the “lost wax” process discussed above.

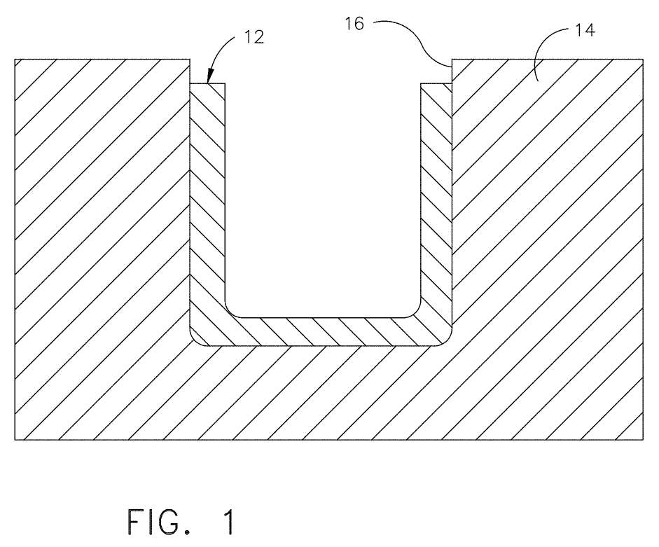

The dense ceramic material forming the backing material or crucible body comprises a ceramic titanate. A preferred ceramic titanate is aluminum titanate, Al₂TiO₅. Referring now to FIG. 1, a crucible body 12 is formed by providing a plaster mold 14 having a cavity 16 that has a predetermined size that is sized larger than the desired cavity of crucible body 12 by the thickness of the crucible body 12 plus the thickness of the non-reactive layers. Thus, if the crucible thickness is nominally 3.5 mm and the diameter of the crucible cavity, including non-reactive layers is nominally 63 mm, the diameter of cavity 16 of plaster mold 14 is nominally 70 mm. These values are exemplary, and the crucible body 12 may be larger or smaller as dictated by the required amount of molten metal for casting, the plaster mold 14 and its cavity 16 being adjusted to produce a crucible of size consistent with the amount of molten metal. Sizing plaster mold 14 to achieve the desired crucible dimensions is within the skill of the art and considers factors such as shrinkage of material that occurs during drying and firing.

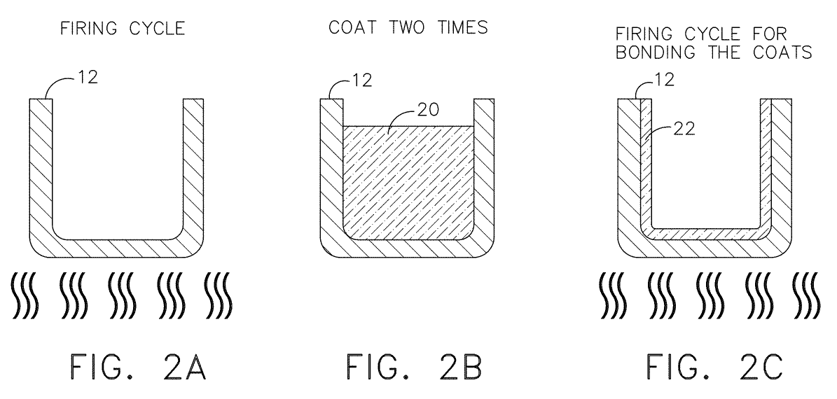

A slurry of finely divided aluminum titanate and a solvent was applied to the plaster mold cavity. The solvent may be any evaporable liquid; however in this example the solvent was water. The slurry may be applied by any convenient method, which includes spraying, pouring, brushing, wetting the surface of the plaster mold. The slurry is allowed to dry and cure. The preferred method is pouring a slurry of the ceramic titanate into the plaster mold. After a predetermined time when a preselected thickness of the slurry has dried against the plaster mold, remaining slurry may be poured out of the plaster mold. The solidified, dried ceramic titanate crucible may then be separated from the plaster mold. If necessary, additional slurry may be applied to the titanate crucible until the predetermined, desired thickness of the crucible body is achieved. Referring now to FIG. 2(a), the dried and cured ceramic body is then fired an elevated temperature sufficient to convert the dried material into a fired ceramic or glass-ceramic. A firing temperature in the range of 1300-1700° C. (about 2370-3090° F.), and preferably about 1600° C., (2900° F.) may be utilized for firing.

The non-reactive facecoat is next applied to the fired ceramic titanate crucible body. Referring now to FIG. 2(b), the facecoat also is applied as a slurry. While the facecoat may comprise any non-reactive material, the preferred non-reactive material for molten TiAl comprises yttria, which is suitable for use with most reactive molten alloys and metals. However, depending on the alloy melted, other non-reactive materials may be used for facecoats. Other preferred facecoats include zirconia and zirconia/yttria mixtures. In this example, the facecoat was applied to the crucible body as two layers, each layer being about 100-200 μm, and the overall thickness of the two layers being 200-300 μm. More layers or a single layer may be used. Furthermore, each layer may be thicker or thinner than the thickness used in this example. As with the ceramic titanate, the non-reactive facecoat may be applied by any convenient method, including but not limited to spraying, brushing or pouring. In this example yttria slurry was poured into the ceramic body, naturally wetting the surface of the fired aluminum titanate. The ceramic body containing the yttria slurry was agitated, and then the excess slurry was poured out of the cavity and allowed to dry. The process was repeated a second time after which the desired thickness was reached. It will be recognized by those skilled in the art that additional applications of the yttria slurry may be applied until the desired thickness of non-reactive facecoat is achieved. Referring now to FIG. 2(c) the applied facecoat is then fired. A firing temperature in the range of 1300-1700° C. (about 2370-3090° F.) and preferably about 1600° C. (2900° F.) may be utilized for this firing operation as well. It will also be recognized by those skilled in the art that the facecoat may be fired after the application of each layer to the ceramic body, although these intermediate firing steps may be superfluous.

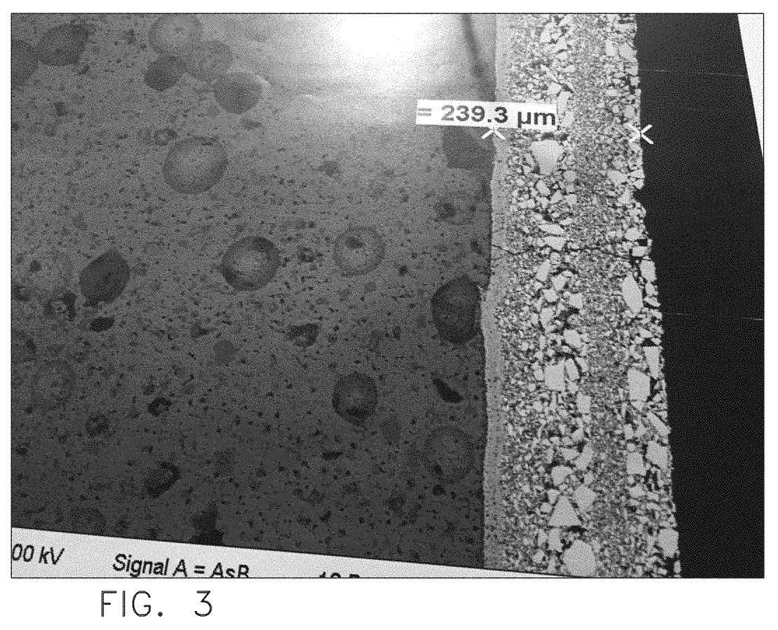

After the firing, the non-reactive coating formed in accordance with the present invention, even though it comprises the same material as prior art non-reactive coatings, has a different structure and different mechanical properties than non-reactive coatings formed by the prior art “lost wax” process. Referring to FIG. 3, which is a cross-section of a crucible 12 formed in accordance with the current process as described above, the non-reactive coating layer 14 has fewer voids than those generated using the “lost wax’ process, and the voids are also smaller. This contributes to a non-reactive coating that is more dense than those generated by the “lost wax” process. This density results in a stronger bond between the aluminum titanate body and the non-reactive layers. As a result of the stronger bond, as the metallic charge in the mold formed in accordance with the present invention is heated, the interface between the aluminum titanate body and the non-reactive yttria layer is better able to withstand the thermal stresses resulting from thermal expansion due to heating of the metal charge, which in this example, was TiAl. Furthermore, during the spin casting operation, the interface can withstand the centrifugal forces associated with the spin operation as metal is transferred from the crucible to the article molds, turbine blades in this example, through runners. Thus, delamination of the non-reactive yttria layer from the ceramic mold is essentially eliminated, and fracturing of the non-reactive layer is all but eliminated, resulting in a reduction of yttria defects in the molten metal, and into the cast articles as the molten metal is cast into the article molds.

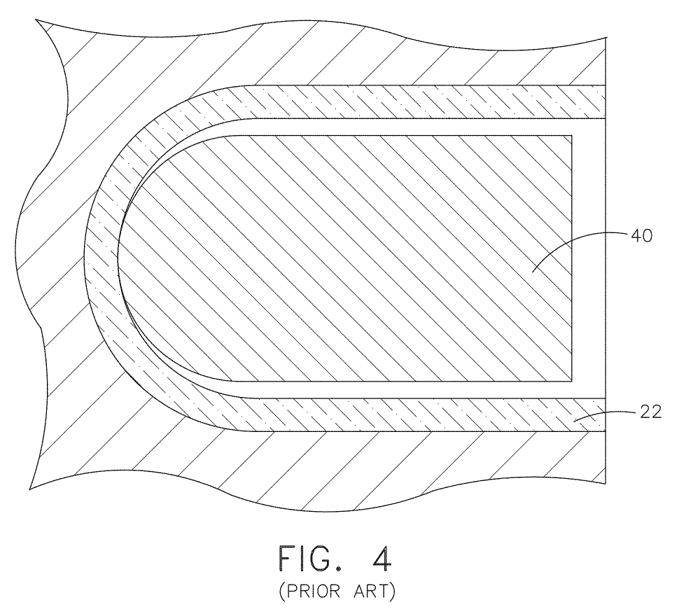

FIG. 4 depicts a cross-section of a prior art crucible illustrating the shape of the crucible cavity. The prior art crucible, like the crucible of the present invention, includes a non-reactive coating 22 lying between the crucible and the furnace charge 40. The cavity includes a charge 40 of reactive alloy. The alloy charge may be machined to take the shape of the prior art crucible, adding further cost to the process. The furnace charge is not so restrictive, although this illustration represents the typical charge. As can be seen in FIG. 4, the crucible interior (and machined crucible charge) has a dome shape. This round bottom dome shape (concave shape) of the crucible necessitates a supporting pin (not shown) within the crucible as a part of the melting process to hold the convex alloy charge flat during the melting process in order to maintain the alloy in a substantially a fixed position within the induction field during the melting process. The crucible made in accordance with the present invention can be fabricated with a substantially flat bottom as illustrated in FIGS. 1 and 2. In contrast to the dome shaped (concave) bottom of the prior art crucible, a crucible made in accordance with the present invention may be made with a substantially flat bottom that maintains the alloy charge in a fixed position while the induction field is applied. The supporting pin may be eliminated from the crucible and the melting process as crucibles having a flat bottom can be fabricated using the novel process set forth herein.

The structural improvements in the crucible of the present invention have been outlined above, specifically the non-reactive layers are more dense as porosity is reduced in the these layers. The increased density results in greater strength in the crucible, which has at least reduced, and possibly eliminated delamination of the non-reactive layer(s) from the crucible body during melting of the reactive metal. This in turn has reduced non-reactive ceramic impurities in metal melted within the crucible. While the amount of reduction varies from melt to melt, the average amount of impurity reduction is about 15%. The reduced non-reactive ceramic impurities in the molten metal have resulted in fewer impurities in the articles formed from the molten metal, resulting in a reduced scrappage rate and better castings. While the process has been demonstrated for articles that are turbine blades, the present invention is not so limited, as the techniques used for forming the novel crucibles of the present invention can be implemented for any articles made from reactive alloys and melted by vacuum induction melting (VIM). The crucibles, comprising a titanate body made in accordance with the present invention also do not require a susceptor and when made with a flat bottom, do not require a support pin, simplifying the manufacturing process.

In addition to these advantages, the manufacturing process used to fabricate the novel crucibles provides additional advantages due to the simplification of the manufacturing process. Shelling lines used for shelling lines required in the “lost wax” process are eliminated. Slurry tanks used to form the shell around the consumable, sacrificial pattern are eliminated. 6-axis robots used to dip and fire the shells can be eliminated. Wax pattern injection machines and associated tooling is eliminated. Facecoat back-up slurry is eliminated. Environmental control systems associated with the preparation of the wax patterns and elimination of the sacrificial patterns and the shelling lines is also eliminated. The elimination of this equipment and all of the steps associated with this equipment result in considerable cost savings over and above that associated with improvements to the castings. While forming plaster molds for crucible body formation is a new cost associated with the new process, this cost is small compared to the cost savings from the equipment eliminated as set forth above. Plaster molds can be reused. Furthermore, forming and disposing of plaster molds at the end of their life also is more environmentally friendly.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A crucible for melting reactive alloys, comprising
a ceramic body including a dense ceramic titanate;
a layer overlying the dense ceramic titanate, the layer being a face layer further comprising a ceramic material that is non-reactive with the molten reactive alloy when in contact with molten reactive alloy; and
wherein the molten reactive alloy is in contact with the face layer.

2. The crucible of claim 1 wherein the ceramic body includes a cavity, and the face layer overlies the ceramic body within its cavity.

3. The crucible of claim 1 wherein the ceramic titanate body further includes at least one ceramic selected from the group consisting of alumina, silicon dioxide, zirconium silicate and combinations thereof.

4. The crucible of claim 1 wherein the ceramic titanate further comprises aluminum titanate.

5. The crucible of claim 2 wherein the overlying layer comprises a plurality of layers of non-reactive ceramic material.

6. The crucible of claim 5 wherein the layer overlying the dense ceramic titanate further comprises a non-reactive ceramic selected from the group consisting of yttrium oxide (yttria), scandium oxide (scandia), zirconium oxide (zirconia), calcium oxide (calcia), hafnium oxide (hafnia), a lanthanide series oxide and combinations thereof.

7. The crucible of claim 1 wherein the crucible cavity has a non-concave bottom that is substantially flat.

8. A process for making a crucible for vacuum induction melting of reactive alloys, comprising the steps of:
providing a plaster mold, the plaster mold having a cavity of predetermined size;
providing a slurry of a ceramic titanate;
applying the slurry of ceramic titanate to the plaster mold cavity to a predetermined thickness;
drying the slurry forming a dried ceramic body having a cavity of predetermined size;
removing the dried ceramic body from the plaster mold;
firing the dried ceramic body, forming a fired ceramic titanate crucible body having a cavity;
providing a slurry of non-reactive ceramic;
applying the slurry of the non-reactive ceramic to the crucible body cavity while wetting cavity walls of the crucible body;
drying the slurry, forming a dried layer on the cavity walls of the crucible body; and
firing the crucible body with the dried layer of non-reactive ceramic, bonding the non-reactive ceramic layer to the crucible body, forming a ceramic titanate crucible with a non-reactive ceramic layer lining the cavity of the ceramic titanate crucible body.

9. The process of claim 8 wherein the step of providing a slurry of ceramic titanate further includes providing a slurry comprising aluminum titanate.

10. The process of claim 8 wherein the ceramic titanate slurry further includes at least one ceramic selected from the group consisting of alumina, silicon dioxide, zirconium silicate and combinations thereof.

11. The process of claim 8 further including additional steps of applying additional slurries of non-reactive ceramic over the crucible body cavity, and drying the slurry over the cavity walls of the crucible.

12. The process of claim 8 wherein step of providing a slurry of non-reactive ceramic includes providing a slurry selected from the group of a non-reactive ceramic consisting of yttrium oxide (yttria), scandium oxide (scandia), zirconium oxide (zirconia), calcium oxide (calcia), hafnium oxide (hafnia), a lanthanide series oxide and combinations thereof.

13. The process of claim 8 wherein the step of firing the dried ceramic body includes firing the dried ceramic body in the temperature range of 1300-1700° C., forming a fired ceramic.

14. The process of claim 8 wherein the steps of applying the slurry of ceramic titanate to the plaster mold cavity to a predetermined thickness and drying the slurry forming a dried ceramic body having a cavity of predetermined size further includes the steps of:
pouring the ceramic titanate slurry into the plaster mold cavity;
drying the ceramic titanate slurry against the plaster mold cavity to a predetermined thickness;
pouring excess ceramic titanate slurry from the plaster mold cavity.

15. A crucible for melting reactive alloys made by the process comprising the steps of:
providing a plaster mold, the plaster mold having a cavity of predetermined size;
providing a slurry of ceramic titanate applying the slurry of the ceramic titanate to the plaster mold cavity to a predetermined thickness;
drying the slurry, forming a dried ceramic body;
firing the dried mold body, forming a fired ceramic titanate crucible body having a cavity;
providing a slurry of a non-reactive ceramic;
applying the slurry of the non-reactive ceramic while wetting cavity walls of the crucible body;
drying the slurry, forming a dried layer on the cavity walls of the crucible body;
firing the crucible body having the applied dried layer of non-reactive ceramic, bonding the non-reactive ceramic layer to the crucible body,
providing a fired ceramic titanate crucible with a non-reactive ceramic layer face layer lining the cavity of the ceramic titanate crucible body for melting of reactive alloys.

16. The process of claim 15 wherein the steps of applying the slurry of the ceramic titanate to the plaster mold cavity to a predetermined thickness and drying the slurry, forming a dried ceramic body wherein the formed dried ceramic body further includes a non-concave bottom that is substantially flat.

17. The process of claim 15 wherein the step of providing a slurry of ceramic titanate further includes providing a slurry comprising aluminum titanate producing an aluminum titanate crucible.

18. The process of claim 17 wherein the ceramic titanate slurry further includes at least one ceramic selected from the group consisting of alumina, silicon dioxide, zirconium silicate and combinations thereof.

19. The process of claim 15 further including additional steps of applying additional slurries of non-reactive ceramic over the crucible body cavity, and drying the slurry over the cavity walls of the crucible forming a ceramic titanate crucible having multiple layers of non-reactive ceramic overlying walls of the crucible body cavity.

20. The process of claim 15 wherein step of providing a slurry of non-reactive ceramic includes providing a slurry selected from the group of a non-reactive ceramic consisting of yttrium oxide (yttria), scandium oxide (scandia), zirconium oxide (zirconia), calcium oxide (calcia), hafnium oxide (hafnia), a lanthanide series oxide and combinations thereof.
